(19) United States
(12) Patent Application Publication
(10) Pub. No.: US 2016/0055487 A1
(43) Pub. Date: Feb. 25, 2016

(54) DETERMINING USER AUTHENTICATION BASED ON USER PATTERNS WITHIN APPLICATION

(71) Applicant: BANK OF AMERICA CORPORATION, Charlotte, NC (US)

(72) Inventors: Elizabeth S. Votaw, Potomac, MD (US); Alicia C. Jones-McFadden, Fort Mill, SC (US); David M. Grigg, Rock Hill, SC (US); Peter John Bertanzetti, Charlotte, NC (US); Michael E. Toth, Charlotte, NC (US); Carrie Anne Hanson, Charlotte, NC (US)

(21) Appl. No.: 14/928,360

(22) Filed: Oct. 30, 2015

Related U.S. Application Data
(63) Continuation-in-part of application No. 14/175,947, filed on Feb. 7, 2014, now Pat. No. 9,185,101.

(51) Int. Cl. G06Q 20/40; G06F 21/31

(52) U.S. Cl. CPC G06Q 20/4014; G06F 21/316

(57) ABSTRACT

Embodiments are directed to systems, methods and computer program products for providing user authentication based on historical user patterns. Embodiments receive from a user, a request to execute a user action associated with an application, wherein execution of the user action requires validation of authentication credentials; collect a set of data comprising information related to user patterns associated with the apparatus of the user; determine a user pattern score associated with the user; determine a level of authentication; determine which authentication types are associated with the level of authentication; request authentication credentials corresponding to the authentication types; receive authentication credentials from the user; validate the authentication credentials, thereby resulting in a successful validation of the authentication credentials; and in response to the successful validation, execute the user action.

### CROSS REFERENCE TO RELATED APPLICATION(S)

This application claims priority to and is a continuation-in-part of U.S. patent application Ser. No. 14/175,947 filed Feb. 7, 2014 and entitled USER AUTHENTICATION BASED ON HISTORICAL USER BEHAVIOR; the contents of which are also incorporated herein by reference.

### BACKGROUND

In the new technological age, the security of personal information, or the lack thereof, has become an issue that concerns many people. As a result, several business industries, such as financial institutions, have taken precautionary measures to ensure the safety and protection of their customers' information. This is typically accomplished by verifying a user's identity prior to transferring any personal information using an electronic means.

### BRIEF SUMMARY

Embodiments of the invention provide user authentication based on historical user patterns. According to embodiments of the invention, an apparatus includes a memory; a processor; and a module stored in the memory, executable by the processor, and configured to communicate, to a computing device, code executable by the computing device that causes the computing device to monitor user patterns of a user based on the user physically interacting with one or more applications executed by the computing device. Based on the computing device monitoring the user patterns, the invention may receive a baseline set of user patterns of the user for identifying the user. From the baseline set of user patterns, the invention may identify one or more routine actions performed by the user while operating the one or more applications executed by the computing device.

In some embodiments of the invention, the invention is configured to receive a request for the user to perform a transaction using the computing device. The transaction is associated with a level of security that must be authenticated prior to completing the transaction. The invention may then receive, from the computing device, an identification set of user patterns of the user based on the user physically interacting with the one or more applications executed by the computing device.

Accordingly, the invention may determine a threshold score based on comparing the identification set of user patterns with the baseline set of user patterns. Based on the threshold score, the invention may alter the level of security that must be authenticated prior to completing the transaction.

In some embodiments of the invention, the invention, the level of security that must be authenticated prior to completing the transaction is one of a hard authentication and a soft authentication. The hard authentication comprises two or more authentication credentials. The soft authentication comprises one authentication credential.

In other embodiments, altering the level of security that must be authenticated prior to completing the transaction comprises changing the level of security. If the level of security is the hard authentication, the invention may change the level of security from a hard authentication to a soft authentication. If the level of security is a soft authentication, the invention may alter the level of security to a no authentication.

Further, the threshold score is associated with one of a fully authenticated tier, a partially authenticated tier, and no authenticated tier. The invention may alter the level of security by: 1) altering the level of security when the threshold score is associated with the fully authenticated tier comprises requiring no authentication credentials prior to performing the transaction; 2) altering the level of security when the threshold score is associated with the fully authenticated tier comprises requiring at least a partial number of the authentication credentials associated with the level of security prior to completing the transaction; and 3) altering the level of security when the threshold score is associated with the fully authenticated tier comprises requiring all of the authentication credentials associated with the level of security and at least one other authentication credential not associated with the level of security.

In other embodiments of the invention, the invention may be configured to communicate a request for the user to submit a response to one or more credentials associated with the level of security. The invention may then receive the response to the one or more credentials associated with the level of security. Accordingly, the invention may authenticate the user based on validating the response to the one or more credentials associated with the level of security. The invention may then perform the transaction based on authenticating the user.

In some embodiments, the user patterns of the user comprise at least one of a time of day when the user physically interacts with the one or more applications, specific pages within the one or more applications accessed by the user, software generated buttons or links selected by the user, user interface controls operated by the user, functions performed by the user, and the like.

While in other embodiments, the security module is further configured to cause the one or more processors to update the baseline set of user patterns using the identification set of user patterns based on receiving validating one or more authentication credentials associated with the level of security.

In yet other embodiments of the invention, the invention may be configured to receive from a user, a request to execute at least one user action from a plurality of user actions associated with an application running on an apparatus. Execution of the at least one user action requires validation of one or more authentication credentials.

The invention may collect a set of data comprising information related to one or more physical user patterns. Such physical user patterns may be based on the user initially physically interacting with an application. Based on the collected set of data, the invention may determine a normal pattern of usage.

After determining the normal pattern of usage of the user, the invention may then determine a present pattern of usage. The present pattern of usage may be based again on the user physically interacting with the application.

Using the normal pattern of usage and the present pattern of usage, the invention may determine a user pattern score of the user. The invention may determine the user pattern score by comparing the present pattern of usage to the normal pattern of usage. By using such a comparison, the invention may determine that the present pattern of usage is outside the normal pattern of usage. The invention sets the user pattern score by determining an extent to which the present pattern of usage is outside the normal pattern of usage.

Using the determined user pattern score, the invention may determine a level of authentication associated with the determined user pattern score and further determine which one or more authentication types from a plurality of authentication types are associated with the level of authentication associated with the user pattern score.

Based on the level of authentication, the invention may request one or more authentication credentials corresponding to the determined one or more authentication types and may receive one or more authentication credentials from the user. The invention may validate the one or more authentication credentials, thereby resulting in a successful validation of the one or more authentication credentials.

In response to the successful validation of the one or more authentication credentials, the invention may execute the at least one user action.

### BRIEF DESCRIPTION OF THE DRAWINGS

Having thus described embodiments of the invention in general terms, reference will now be made to the accompanying drawings, where:

FIG. 1A provides a diagram illustrating an authentication continuum, in accordance with an embodiment of the present invention;

FIG. 1B provides a diagram illustrating an application functions permitted continuum, in accordance with an embodiment of the present invention;

FIG. 1C provides a diagram illustrating multiple continuums, in accordance with an embodiment of the present invention;

FIG. 2 provides a diagram illustrating a network environment for providing authentication using previously-validated authentication credentials, in accordance with an embodiment of the present invention;

FIGS. 3A and 3B provides a flow diagram illustrating a method for user authentication based on transaction data, in accordance with embodiments of the invention; and

FIG. 4 provides a provides a flow diagram illustrating a method for user authentication based on the user physically interacting with one or more applications executed by a computing device, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

User authentication may be required in a variety of situations. For example, a user may be required to authenticate identity for access to an application on a computer system or a mobile device or for access to a particular feature, function or action of an application. Numerous types and levels of user authentication exist. For example, a user may authenticate his or her identity using a unique alias such as a username and/or password. Further, in some situations, challenge questions, familiar pictures and/or phrases, biometrics, key fob-based alphanumeric codes and/or collocation, authentication of another application such as a similar application or an “overarching” application, and/or the like may be used as types of identity authentication.

The different types of authentication may provide differing degrees of confidence regarding the authentication using such types. For example, if a username by itself is used for a first user authentication, and a username along with a password is used for a second authentication, then the second authentication should provide a higher confidence regarding the authentication because of the additional layer of authentication required. Further, within the types of authentication, varying levels of confidence may be used. For example, when using a password, an administrator may require users to create a password according to strict rules designed to increase the security level of the password, and therefore increase the confidence of any authentication using the password.

Accordingly, a continuum of authentication may be used to quantify (or dictate) the levels of authentication. Likewise, a continuum of functions permitted may be used to quantify (or dictate) the number or context in which functions are permitted.

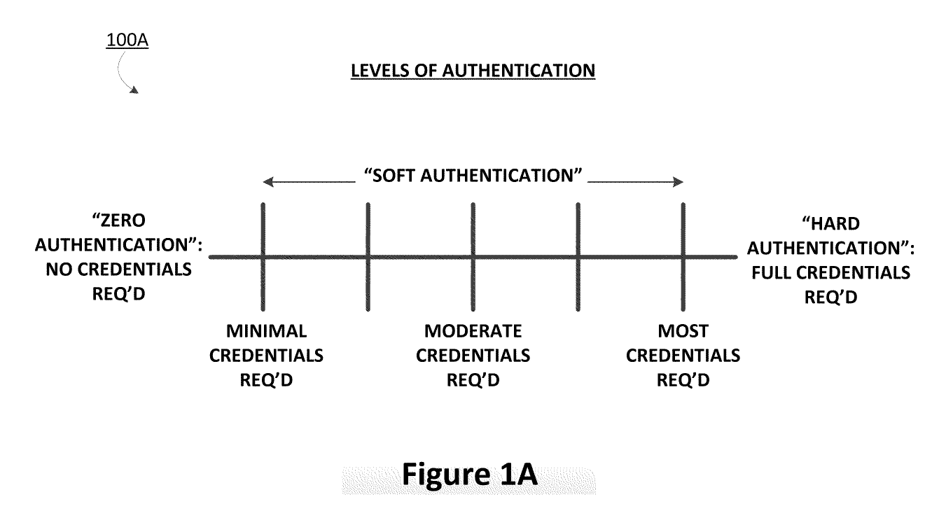

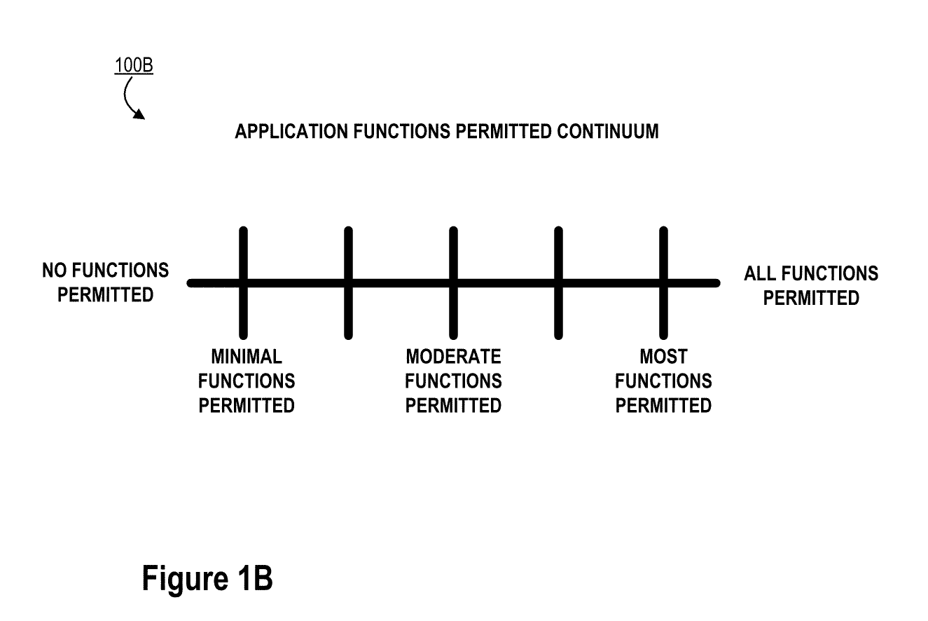

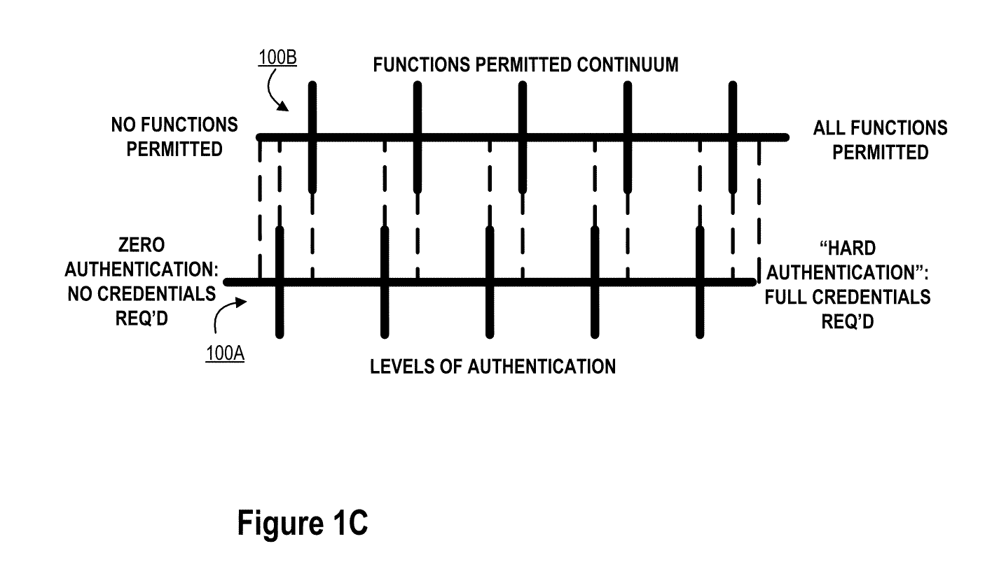

Referring to FIG. 1A, a continuum of authentication 100A is illustrated according to embodiments of the invention. On the left-hand side of the continuum, a “zero authentication” requires no authentication credentials. On the right-hand side of the continuum, a “hard authentication” requires full authentication credentials. This means that it requires the strictest combination of credentials. In between the two extremes, “a soft authentication” requires minimal credentials, moderate credentials or most credentials for various points along the continuum. The continuum generally represents the number of credentials required and/or the relative strength of the credentials required for that point on the continuum. As discussed below with reference to FIG. 1C, the continuum of authentication 100A may be coupled with an application functions permitted continuum 100B, first illustrated in FIG. 1B.

Referring to FIG. 1B, the application functions permitted continuum 100B illustrates various levels of application functions permitted. Functions may refer to what a user is permitted to “see” and/or what the user is permitted to “do”. More specifically, this may refer to whether a specific function is permitted at a certain point on the continuum and/or the context in which a certain function is permitted. The left-hand side of the continuum indicates that no functions are permitted, and the right-hand side of the continuum indicates that all functions are permitted. In between the extremes, minimal functions are permitted, moderate functions are permitted and most functions are permitted. Thus, any given point along the continuum 100B corresponds with a certain amount and/or number of functions that are permitted and/or the context in which certain functions are permitted.

Referring now to FIG. 1C, a diagram 100C illustrates a coupling of the application functions permitted continuum 100B and the levels of authentication continuum 100A. As shown, the continua 100B and 100A may be coupled with one another such that the various points along the continua intersect at specific points of the coupled continuum. For example, one continuum may be moved left or right with respect to the other continuum in order to achieve a different relationship between the functions permitted and the credentials required. Accordingly, for a given coupling, a specific point on continuum 100B provides that a particular function or functions may be permitted given that a specified level of authentication credentials are supplied, as indicated by the corresponding point on continuum 100A. For example, a financial institution and/or a user may arrange the continua 100B and 100A with respect to one another and may adjust the arrangement based on changing desires or goals.

In some embodiments, one or both the continua 100B and 100A may have weighted scales such that, as a point on the continuum is moved, the corresponding functions permitted and/or level of authentication required may change exponentially or otherwise. Furthermore, in various embodiments, other representations of the various functions permitted that correspond with the various levels of authentication may be used by the invention.

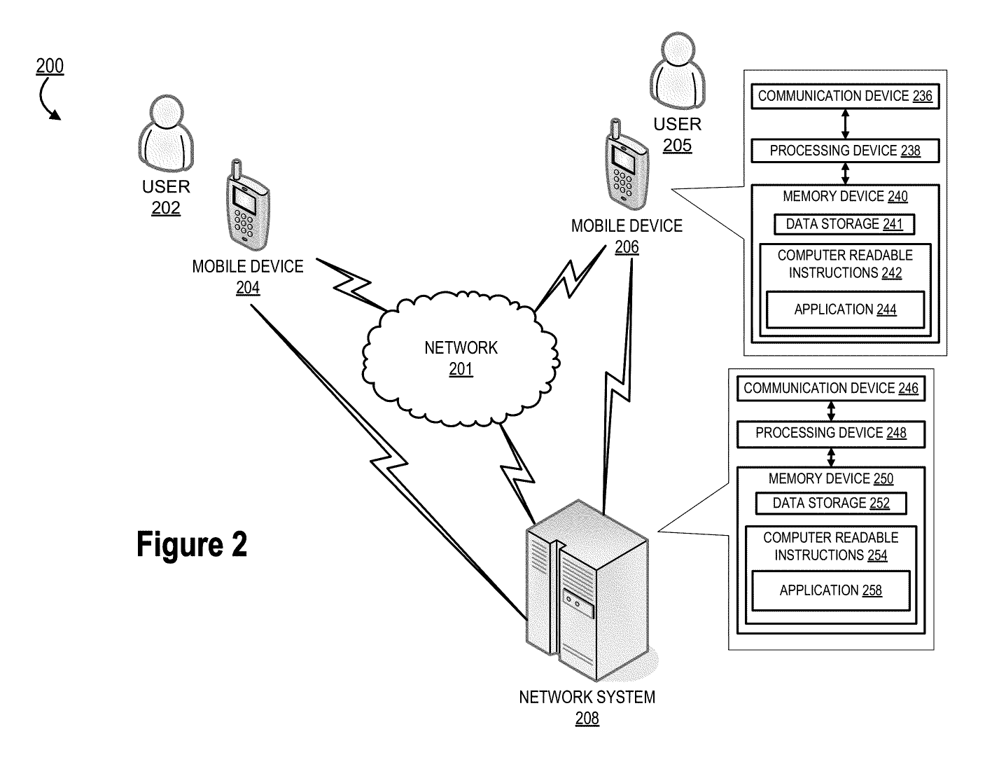

Referring now to FIG. 2, a network environment 200 is illustrated in accordance with one embodiment of the present invention. As illustrated in FIG. 2, the network system 208 is operatively coupled, via a network 201 to the mobile device 204 and/or 206. In this configuration, the network system 208 may send information to and receive information from the mobile device devices 204 and/or 206. The network system 208 may be or include one or more network base stations or other network components. FIG. 2 illustrates only one example of an embodiment of a network environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), a telecommunication network or any other type of network or combination of networks. The network 201 may provide for wireline, wireless, or a combination wireline and wireless communication between devices on the network 201.

In some embodiments, the users 202 and 205 are individuals who maintain cellular products with one or more providers.

As illustrated in FIG. 2, the network system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201. As such, the communication device 246 generally comprises a modem, server, or other device for communicating with other devices on the network 201.

As further illustrated in FIG. 2, the network system 208 comprises computer-readable instructions 254 stored in the memory device 250, which in one embodiment includes the computer-readable instructions 254 of an application 258. In some embodiments, the memory device 250 includes data storage 252 for storing data related to and/or used by the application 258. The application 258 may perform a user authentication by performing one or more of the steps and/or sub-steps discussed herein.

As illustrated in FIG. 2, the mobile device 206 generally comprises a communication device 236, a processing device 238, and a memory device 240. The processing device 238 is operatively coupled to the communication device 236 and the memory device 240. In some embodiments, the processing device 238 may send or receive data from the mobile device 204, and/or the network system 208 via the communication device 236 over a network 201. As such, the communication device 236 generally comprises a modem, server, or other device for communicating with other devices on the network 201.

As further illustrated in FIG. 2, the mobile device 206 comprises computer-readable instructions 242 stored in the memory device 240, which in one embodiment includes the computer-readable instructions 242 of an application 244. In the embodiment illustrated in FIG. 2, the application 244 allows the mobile device 206 to be linked to the network system 208 to communicate, via a network 201. The application 244 may also allow the mobile device 206 to connect directly (i.e., locally or device to device) with the mobile device 204 for proximity services (e.g., using either cellular based links or non-cellular based links). The application 244 may perform a user authentication by performing one or more of the steps and/or sub-steps discussed herein.

It is understood that the servers, systems, and devices described herein illustrate one embodiment of the invention. It is further understood that one or more of the servers, systems, and devices can be combined in other embodiments and still function in the same or similar way as the embodiments described herein.

Various embodiments of the invention retrieve historical patterns of user behavior and compare them to the current situation. In particular, the system may require a lower level of authentication if it confirms information indicating that the user attempting to access an account or perform some other function/action is likely to be the customer based on the historical pattern of the customer.

For example, a customer may typically make 2-4 phone calls in the morning and 2-4 phone calls in the afternoon on a weekday, but the user of the mobile device has not done so in the last 24 hours. Such a fact may indicate that someone who makes a request for an action from the user's mobile device is less likely to be the user, and therefore, a harder or higher level of authentication may be required for the requested action.

In various embodiments, any action performed by the user on the mobile device may be patterned to determine normal patterns of the user and then used in comparison to currents patterns of use leading up to a request for an action/function. Examples of other actions that may be patterned include text messaging, emails sent from the mobile device, web surfing and the like.

In the event that a user making a request has behavior that falls outside predetermined thresholds for normal behavior, then a higher level of authentication will be required. In some embodiments, multiple characteristics or patterns of the user may be analyzed to determine a number of characteristics that fall within or outside predetermined thresholds indicating a normal usage of the user. For example, if the system considers ten characteristic patterns of the user, and 9/10 of them are within normal patterns, then a soft authentication may be required for the requested action. On the other hand, if the system considers ten characteristic patterns of the user, and 2/10 of them are within normal patterns, then a hard authentication may be required for the requested action.

In some embodiments, the extent to which the user is outside normal patterns may be considered in determining the level of authentication required. For example, if the user typically makes 25 phone calls in one day and has not made any phone calls, then the level of authentication may be moved very high or hard due to the great difference between the normal pattern and the actual behavior of the user.

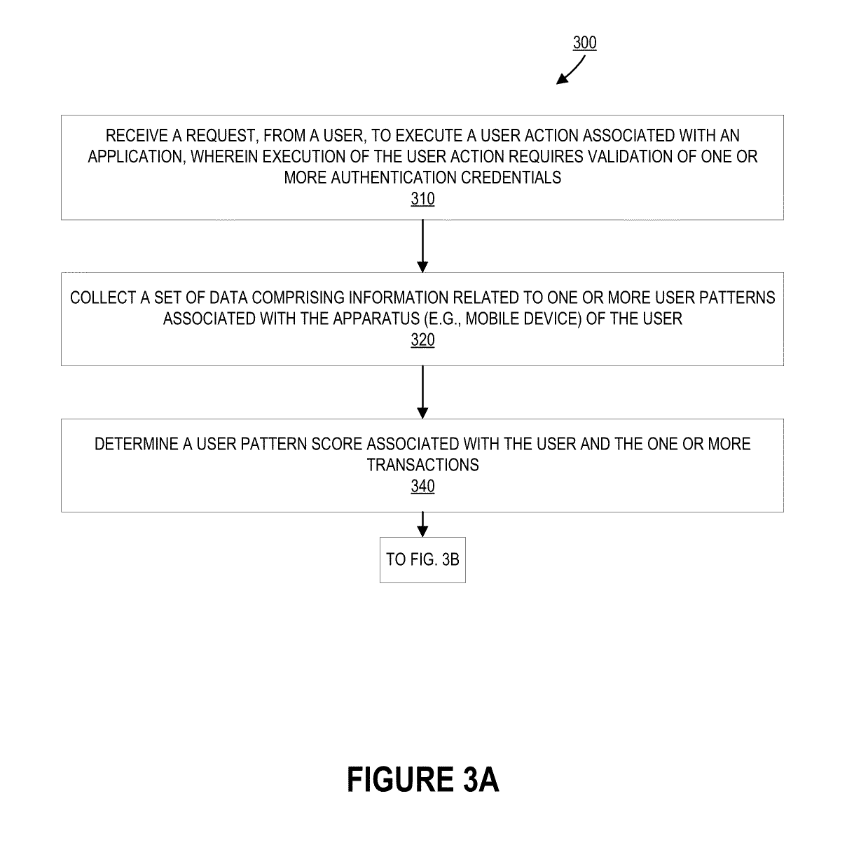

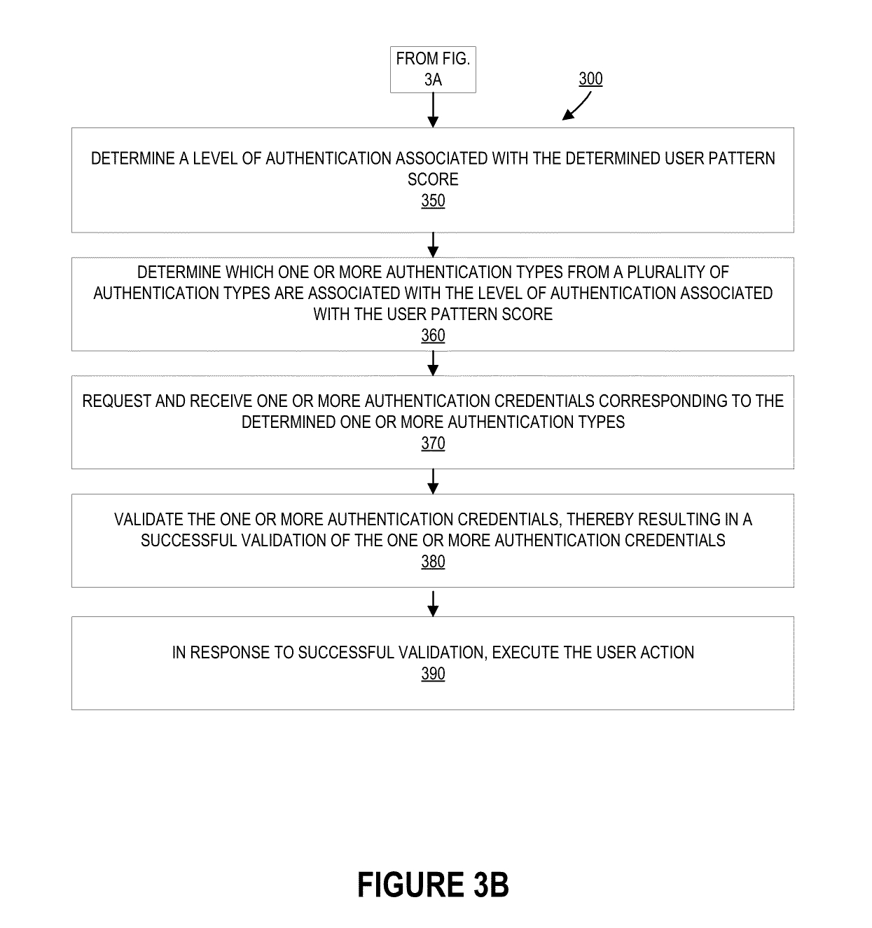

Referring now to FIG. 3A, a flowchart illustrates a method 300 for user authentication based on transaction data. The first step, represented by block 310, is to receive a request, from a user, to execute a user action associated with an application, where execution of the user action requires validation of one or more authentication credentials. Typically, the application may include one or more user actions or functions. For example, a mobile financial application may include functions such as a funds transfer, a check deposit, a balance check, a bill pay, or the like. In another example, the user action may be checking account balance, executing a money transfer, initiating a bill pay to a merchant, or the like.

The next step, represented by block 320, is to collect a set of data comprising information related to one or more user patterns associated with the apparatus (e.g., mobile device) of the user. The set of data may include data regarding power cycles, application access/requests, communications sent and/or received such as SMS messages, text messages, emails, phone calls made, charging times and durations, movement and/or location of the apparatus and/or the like.

The movement and/or location of the apparatus may be determined in a variety of ways such as by collecting a set of data comprising information related to a physical location of the user. This set of data may be collected from a variety of sources and may include data drawn from one or more of the sources. The set of data may include positioning data of the customer, consistent with embodiments of the present invention.

The positioning data may include global positioning data. Global positioning data may include any information collected from methods, systems, apparatus, computer programs etc. involving locating a user's position relative to satellites, fixed locations, beacons, transmitters or the like. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system or the like. The amount, nature and type of the global positioning data that is collected may depend on the merchant's relationship with the customer and the amount of information that the customer has authorized the merchant or third-party provider to collect.

For instance, in some embodiments, the global positioning data will be snapshots of the user's location at different times. For example, a snapshot of the user's location may be collected each time the GPS software, navigation system or application is activated. The global positioning data may also include the destination entered by the user, recent searches for locations, attractions, addresses etc. In other instances, the global positioning data may be the complete route being provided to the GPS system's user, including destination, route, alternate routes, anticipated time of arrival etc. In some such embodiments, the global positioning data may include an indication if the customer selects a detour from a previously selected route, or instructs the navigation system to reach the desired location taking specific roads or avoiding certain roads.

Positioning data of the customer may include mobile device data. Mobile device data may include information regarding the location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

Positioning data of the customer may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the customer's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in”, “flag” or otherwise indicate the user's current location. Accordingly, customer positioning data collected from social networking data may consist of such indications. Furthermore, many social networks allow users to rate, like, comment etc. on restaurants, attractions, locations and the like. Accordingly, a customer may indicate that she ate at a certain restaurant or business at a given time and thereby provide information about her location at that time. Furthermore, a customer may upload photographs to a social networking site and thereby provide information about the customer's location. In some instances the customer's location may be determined from the picture, (for example a picture of a state line sign, a highway sign, a mile marker etc.) or a caption associated with the picture may indicate the customer's location and/or the time the photo was taken.

Positioning data of the customer may also be collected from Internet data. Internet data, may include any information relating to the searches conducted by the customer, website's visited by the customer and the like that suggests the customer's present or future location(s). For instance, in preparing for a vacation a customer may conduct searches for hotels, restaurants or activities in the area where the customer will be staying. Similarly, a customer may review weather forecasts for locations other than her place of residence indicating that she may soon be traveling to that location. A customer may also search for construction or traffic reports indicating future travel along certain roads. Moreover, changes in search patterns may suggest a customer's future location. For instance if a customer usually uses a web browser application just to read online news articles or to check sports scores but suddenly begins to search for camping gear, hiking manuals and boots it may be indicative that the customer is anticipating taking a hiking trip and will be traveling away from her home area. It will be understood that such Internet data may relate to searches or websites visited by the customer before she began traveling, however, inasmuch as many mobile devices also include mobile Internet connectivity, it will also be understood that such information may be dynamically collected as the customer travels.

The next step, represented by block 340, is to determine a user pattern score associated with the user. The user pattern score is a quantification of how close the user's current pattern(s) of behavior are to historical pattern(s) of behavior, and therefore, indicates a relative level of potential exposure for a user request. Methods for determining the user pattern score are discussed below.

Referring now to FIG. 3B, the next step, represented by block 350, is to determine a level of authentication associated with the determined user pattern score. Then, the system may be configured to determine which one or more authentication types from a plurality of authentication types are associated with the level of authentication associated with the user pattern score, as shown in block 360. As illustrated in at least FIG. 1A, the one or more authentication levels may include a hard authentication, a soft authentication, and a zero authentication. In one aspect, the authentication types may include a username, a password, a personal identification number, biometric data, or the like. In some embodiments, each authentication level may include one or more authentication types in the continuum of authentication.

In response to determining one or more authentication types, the system may be configured to request one or more authentication credentials corresponding to the determined one or more authentication types, as shown in block 370. In response to requesting one or more authentication credentials, the system may be configured to receive one or more authentication credentials from the user and validate the one or more authentication credentials, thereby resulting in a successful validation of the one or more authentication credentials, as shown in blocks 370 and 380. In response to successful validation of the one or more authentication credentials, the system may then be configured to execute the user action, as shown in block 390. In one aspect, a successful validation may include determining a successful match between the one or more authentication credentials received from the user and the one or more authentication credentials stored in a database, wherein the one or more authentication credentials correspond to the one or more authentication types associated with the level of authentication.

Determining the user pattern score (see FIG. 3, block 340) may be done in a variety of methods. For example, in some embodiments, determining the user pattern score includes determining a threshold associated with one or more apparatus activities, determining whether a current pattern of the user is within the threshold, and, based at least in part on the determination, assigning the user pattern score. The threshold(s) may be predetermined by the financial institution and/or may be predetermined and/or modified by the customer, such as by using the customer's online banking access.

In some embodiments, determining the user pattern score includes selecting one or more second apparatus activities and determining a second threshold associated with the one or more second user patterns, determining whether the user is within the second threshold, where determining the user pattern score is further based at least in part on the determination of whether the user is within the second threshold.

In some embodiments, determining the user pattern score includes determining a first partial score based at least in part on the determination of whether the user is within the threshold, where the first partial score is weighted by a first weighting factor and determining a second partial score based at least in part on the determination of whether the user is within the second threshold, and where the second partial score is weighted by a second weighting factor. The partial scores may then be combined such as by summing or multiplying to determine the user pattern score.

The weighting factors may represent one or more user-defined preferences regarding their respective apparatus activities such as indicating which activities should be weighted more heavily.

In some embodiments, determining the user pattern score includes determining a historical user pattern associated with the user, determining whether the set of data indicates a current pattern that falls within a predetermined acceptable variance of the historical pattern, and, if not, determining the user pattern score based at least in part on a variance of the current pattern from the historical pattern. In some embodiments, determining the user pattern score comprises determining a historical pattern associated with the user and determining the user pattern score based at least in part on a variance of the current pattern from the historical pattern.

In various embodiments, the user pattern score may be looked up in a database to determine a corresponding level of authentication required for the user pattern score. In some cases, certain ranges of user pattern scores are assigned a particular level of authentication. In some cases, these levels of authentication are managed and predetermined by the financial institution and in some cases, the user/customer may either modify already predetermined levels of authentication and/or set the predetermined levels of authentication.

In various embodiments, the level of user authentication may also be based in part on validating an identity of the mobile device of the user. Such verification can be incorporated into the close network score or into a unique identity score that is combined with the close network score in order to determine the appropriate level of authentication required for a requested action/function. The identity of the mobile device may be determined in a variety of ways. For example, a particular mobile device may be identified by gathering device identification information from the mobile device to generate the device's “fingerprint,” or unique signature of the mobile device. Device identification information may be collected from a variety of sources. In some embodiments, the device identification information includes an identification code. The identification code may be but is not limited to a serial number or an item number of the device. In some embodiments, the device identification information may be associated with a chip associated with the mobile device. The chip may be but is not limited to a subscriber identification module (SIM) card, removable hard drive, processor, microprocessor, or the like. In other embodiments, the device identification information may be associated with a removable part of the mobile device. Removable parts include but are not limited to detachable keyboards, battery covers, cases, hardware accessories, or the like. Removable parts may contain serial numbers or part numbers. In alternative embodiments, a unique key, code, or piece of software provided by a financial institution may be downloaded onto the mobile device. This unique key, code, or piece of software may then serve as device identification information. Typically, the device identification information (e.g., a serial number, an identification code, an International Mobile Station Equipment Identity (IMEI), a phone number, a chip, a removable part, or similar pieces of device identification information) is collected from the mobile device without requiring user input. For example, the device identification information may be automatically provided by the mobile device. Alternatively, the mobile device may provide the information without requiring user input after receiving a request from a system for the identification information. In other embodiments, device identification information may be entered manually at the mobile device. For example, if the mobile device's serial number cannot be automatically located (perhaps due to interference, long range, or similar hindrance), the user may be prompted for manual entry of the serial number (or an identification code, an International Mobile Station Equipment Identity (IMEI), a phone number, a chip, a removable part, or similar pieces of device identification information). The device identification information may be stored and subsequently used to identify the mobile device.

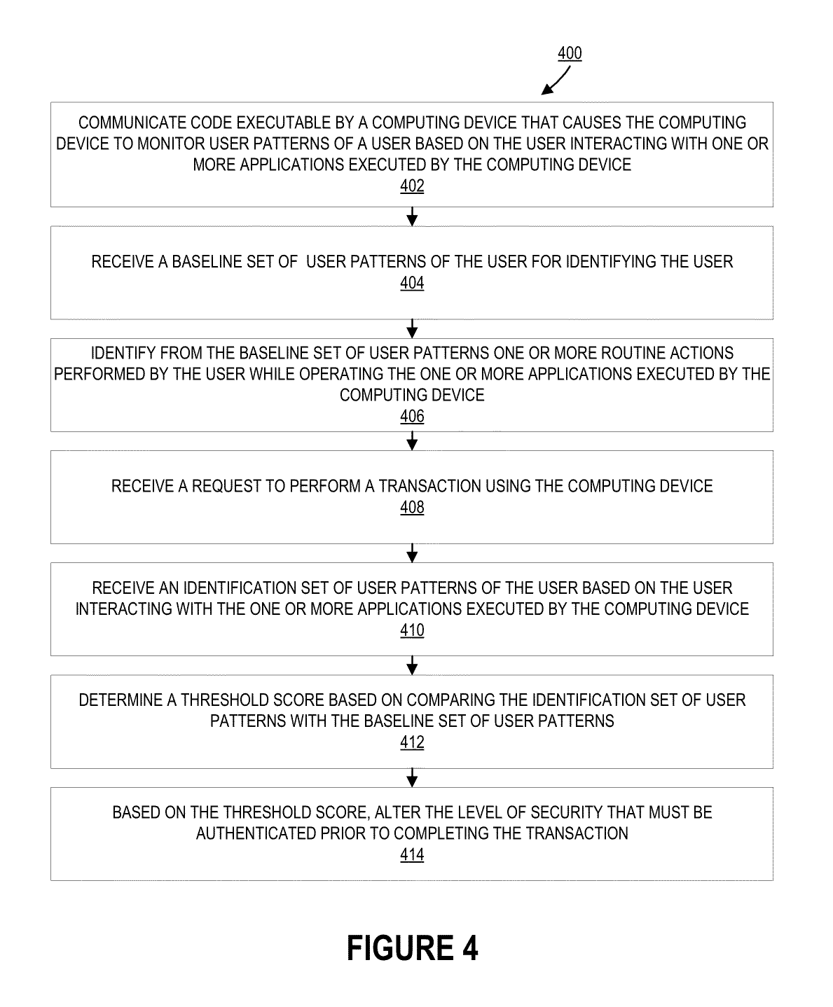

Referring now to FIG. 4, a flowchart illustrates a method 400 for user authentication based on the user physically interacting with one or more applications executed by the computing device. The first step, represented by block 402, is to communicate, to a computing device, code executable by the computing device that causes the computing device to monitor user patterns of the user base on the user physically interacting with one or more applications executed by the computing device. The computing device may be a mobile device of the user, such as a mobile phone, a smart phone, an MP3 player, a digital organizer, and the like. Additionally, the computing device might also refer to another computing device such as a desktop or a laptop computer. In all cases, the computing device will be capable of installing and executing applications. These applications may be physically interacted with by a user. A user may physically interact with each of these applications based on hardware and/or software capabilities of the computing device. For example, the computing device may include user input controls such as buttons, switches, a touch screen, and the like. The computing device may be able to sense when the user physically interacts with a user input control, such as pressing a button or swiping the user interface.

In addition to the hardware and software configurations of the mobile device, each application may include features for allowing a user to directly interact with the application. For example, an application may have an associated graphical user interface that is presented on a display of the computing device. Such graphical user interface may include pages that are presented to the user. Each of these pages may include static and dynamic content. The static content may include non-intractable information. Dynamic content may include information and features that are intractable by the user. Such dynamic content may include navigation controls to pages within the application, navigation controls to content outside the application, features that trigger the computing device to perform a function, updateable elements, and the like.

The application may further include a historical tracking feature that stores information about how the user physically interacts with the application. Tracking may include which pages a user views of the application, which interactive features the user interacts with of the application, a method of interaction (pressing a button, swiping), and the like.

Further, the code executable by the computing device is capable of tracking when a user enters or exits an application, and a chain of applications with which the user interacts. For example, a user may interact with a first application that includes a feature, when selected by a user, causes the computing device to exit the first application and start a second application. The tracking feature would identify the time the user initiated the first application, the feature selected by the user, the time the user exited the first application, a page of the first application that included the feature when the user exited the first, and the time the user entered the second application.

In some embodiments, the application may track states of the application. An example of state may include the application tracking whether a user is signed in to the application or whether the user is viewing the application as a guest. Further, state may include features of the computing device itself (e.g. computing device offline or connected to the Internet). The application may detect interactions of the user with the application during a given state of the application or computing device. For example, a mobile device may be configured to connect to a wireless network and may identify wireless networks to join and presents an option to the user to join one of the networks. When the user selects a network to join, a recording is made as to the state of the computing device. This state may indicate that the computing device is connected to a wireless network and that the computing device is connected to a specific wireless network. A user may then open up an email application and request to receive email communications while connected to the particular network. A recording is made that the user requested email communications while connected to the specific network.

Another feature of an application that may be associated with an interaction of the user may be trigger events. Trigger events occur when an application identifies certain conditions to be true and as a result, automatically performs a function. For example, a messaging application may identify when a message is received, and as a result displays a notification to the user of such. A recording may be made based on the subsequent interaction of the user with the application after the triggering event. Following the messaging example, after receiving the notification of receiving the message, the user may open the application to read the message. A recording may be made based on the amount of time between the triggering event and the user opening the application.

Information may be collected as to the content of the trigger. For example, a recording may be made as to a sender of a message received by a messaging application installed on the computing device. After receiving the message, the system may record whether the user responds back to the message based on the sender.

In other embodiments, the computing device may include other hardware or sensors that are made available to the code executable by the computing device or the applications. These sensors may include global positioning system devices, light sensors, touch sensors, accelerometers, biometric scanners, and the like. A physical interaction of the user with an application may be associated with a reading from one of these sensors. For example, when an interaction is detected, a recording may be made of the interaction and associate that interaction with a location determined by a global positioning system device.

Block 404 illustrates receiving, from the computing device, a baseline set of user patterns of the user for the purpose of identifying the user. These user patterns are based on the user physically interacting with the one or more applications installed on the computing device. Using this baseline set of user patterns, identification may be performed to determine one or more routine interactions of the user while the user is interacting with the one more applications installed on the computing device, as illustrated in Block 406. Identifying the routine action is dependent upon the particular interaction and or recorded history of interactions of the user. For example, a messaging application may identify that a message has been received and as a result, the messaging application causes the computing device to display a notification to the user. As explained above, a recording may be made that a notification was displayed. An analysis of the message may identify a sender of the message and a content of the message. Using an accelerometer, the system may determine that the computing device is in the possession of the user and that the volume on the computing device is sufficient as to alert the user to the notification. A recording may be performed to determine the time between the user receiving the notification and the user physically interacting with the messaging application to read the message. Thus, the system identifies a routine action performed by the user of how long between receiving a message and opening the messaging application. Additionally, further analysis may be performed to determine, based on the sender, whether the user opens the messaging application to view the message and/or make a response. In yet further analysis, a determination may be made as to whether the user is in a meeting based on interfacing with a scheduling application installed on the computing device. A determination may be made that the user does not view messages when the user is in a meeting until after the meeting.

In another embodiment, tracking how the user physically interacts with the application may further include determining which areas of the application the user typically views and/or how much time the user views a particular area of the application. For example, an application may have scrollable content and the user typically scrolls down the content until a particular piece of information is displayable. Thus, tracking is performed on content that is displayed on the screen or an area of the application to which the content is assigned. In term of a web application, a web page may be communicated to a browser, but not all of the web page may be viewable at one point in time. This is especially true with smaller screen sizes such as mobile devices. Content is sectioned into areas of the web page that are displayable when the user scrolls to that particular area. When a particular area is displayed, tracking is performed to determine the content, the area displayed, and the amount of time the user spent looking at the area. Tracking is also performed to determine areas that the user did not view or simply scrolled over quickly.

In embodiments where the application has multiple pages or multiple areas that are navigable, tracking may be performed to determine the order in which the user views each of the areas or performs functions within each area. For example, the application may be a banking application and the user selects a first page, followed by a second page, followed by a third page. Therefore, tracking may be performed to determine how the user typically navigates through the application.

Block 408 illustrates receiving a request from the user, to perform a transaction using the computing device, where the transaction is associated with a level of security. In some embodiments, the transaction may be associated with an application installed on the computing device. For example, a computing device may have a banking application installed which allows the user to perform financial transactions on a bank account. In other embodiments, the transaction may be associated with the computing device itself (e.g. unlocking the computing device, changing a setting).

In some embodiments, the level of security may comprise one or more credentials that must be authenticated prior to the execution of the function. The credentials may include a username, a password, a personal identification number (PIN), a security token, and the like. In some embodiments, the level of security associated with the transaction may be one of a hard authentication or a soft authentication, as defined herein.

Block 410 illustrates receiving, from the computing device an identification set of user patterns of the user. Similar to the baseline set of user patterns, the identification set of user patterns is based on the routine physical interactions described herein. Additionally, these routine physical interactions are monitored using the same methods and processes as described herein. For example, a messaging application may receive a message from a particular sender. Baseline information may suggest that the user typically opens up the messaging application within a given period of time after receiving notification from the messaging application of the message. A recording is made as to the length of time between the user receiving the message and the user opening the application.

Block 412 illustrates determining a threshold score based on comparing the identification set of user patterns with the baseline set of user patterns. In some embodiments, the identification set of user patterns are compared to the baseline set of user patterns. This comparison is dependent upon the actual user patterns, described herein, being compared. Such comparison may include statistical analysis in determining the threshold score. For example, where a messaging application notifies the user of an incoming message and the user typically opens up the messaging application when the message is communicated by a given sender, a comparison is made as to the amount of time it took the user to open the application. This is compared against baseline data previously recorded. If the messaging application determines that the identification information is outside a given threshold from the baseline information, further analysis may be performed to determine a reason for the abnormality. For example, the content of the message may include a simple phrase that is displayed in the notification to the user, such as “OK”. A determination would be made that the user would not need to view the message from the messaging application. However, a determination may be made that the user viewed the notification based on the computing device sensing the computing device was picked up by the user.

Where there is a deviation between the baseline set of user patterns and the identification set of user patterns, the system may tag the deviation. Such tagging may result in requesting the user, via a prompt, to perform an action to identify the user. The user may use the same computing device on which the application is executed to perform the identification. In some embodiments, the prompt may request the user perform the identification using a secondary device (e.g. wearable device). In other embodiments, the prompt may request the user to perform a video authentication of the user. Such video authentication may be performed using a camera of the device or another device.

In some embodiments, the threshold score is categorized into one of multiple tiers. The tiers might include a tier for full authentication, a tier for partial authentication, and a tier for no authentication. In block 414, an alteration of the level of security may be performed based on the tier to which the threshold score has been categorized. If the threshold score was categorized into the full authentication tier, the level of security may be altered to require the user submit no credentials prior to performing the transaction. If the threshold score was categorized into the partial authentication tier, the level of security may be altered to require the user submit some or all of the credentials associated with the level of security. For example, a level of security may require the user submit a username and a password prior to performing the transaction. Based on the threshold score being categorized in the partial authentication tier, the level of authentication may be altered such that the user may only be required to enter into the password prior to performing the transaction. Where the threshold score is categorized into the no authentication tier, the level of security may be altered such that the user may be required to submit at least all of the credentials associated with the level of security. In some embodiments the level of security may be altered such that the user may be required to submit additional credentials in addition to the credentials associated with the level of security. For example, a level of security may require a user submit a username and password prior to completing a transaction. Based on a threshold score being categorized into a tier of no authentication, a user may be required to submit the username and password, and a personal identification number (PIN) prior to the transaction being executed. For example, a banking application may determine that a user, at a given time each day: accesses pages of the banking application to review balances of financial accounts managed by the user; accesses a page to review transactions performed on the previous day; and a page to review a budget of the user. On a particular day, the application may identify that the user only reviews the balances of the financial accounts and does not review the transactions or the budget. As a result, a determination is made that the user is partially authenticated. However, if the application determines that the user accesses a page for transferring money to an external account, without performing the daily routine, a determination may be made of no authentication.

In other embodiments, where the level of security is associated with a hard or a soft authentication level, the level of security may be altered to lower the authentication level lower than an original level of level of security. For example, if the level of security is associated with a hard authentication, the level of security may be altered to be associated with a soft authentication. Additionally, if the level of security is associated with a soft authentication, the level of security may be altered to be associated with no authentication.

In addition to altering the level of security, a system performing the steps described herein may be configured to communicate a request for the user to submit a response to one or more credentials associated with the level of security or an altered level of security. Based on communicating such a request, a user may submit a response that includes the one or more credentials associated with the level of security or the altered level of security. After receiving the credentials, the system may authenticate user based on validating the one or more credentials. Finally, after validating the user, the system may perform the transaction.

If the user is required to submit credentials associated with the level of security or the altered level of security, the system may update the baseline set of user patterns using the identification set of user patterns. The system updates the baseline set of user patterns after authenticating the user. Thus, the system continuously updates patterns associated with the user. When the system does not recognize a pattern of the user, the system requests the user submit credentials to authenticate the user and then updates the baseline set of patterns based on new patterns.

In yet other embodiments of the invention, the invention may be configured to receive from a user, a request to execute at least one user action from a plurality of user actions associated with an application running on an apparatus. Execution of the at least one user action requires validation of one or more authentication credentials.

The invention may collect a set of data comprising information related to one or more physical user patterns. Such physical user patterns may be based on the user initially physically interacting with an application. Based on the collected set of data, the invention may determine a normal pattern of usage.

After determining the normal pattern of usage of the user, the invention may then determine a present pattern of usage. The present pattern of usage may be based again on the user physically interacting with the application.

Using the normal pattern of usage and the present pattern of usage, the invention may determine a user pattern score of the user. The invention may determine the user pattern score by comparing the present pattern of usage to the normal pattern of usage. By using such a comparison, the invention may determine that the present pattern of usage is outside the normal pattern of usage. The invention sets the user pattern score by determining an extent to which the present pattern of usage is outside the normal pattern of usage.

Using the determined user pattern score, the invention may determine a level of authentication associated with the determined user pattern score and further determine which one or more authentication types from a plurality of authentication types are associated with the level of authentication associated with the user pattern score.

Based on the level of authentication, the invention may request one or more authentication credentials corresponding to the determined one or more authentication types and may receive one or more authentication credentials from the user. The invention may validate the one or more authentication credentials, thereby resulting in a successful validation of the one or more authentication credentials.

In response to the successful validation of the one or more authentication credentials, the invention may execute the at least one user action.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. | | |
|---|---|---|---|
| | patent | | |
| | appli- | | |
| | cation | | |
| Docket Number | Ser. No. | Title | Filed On |
| 6017US1CIP1.014033.2560 | To be | DETERMINING | Con- |
| | assigned | USER AUTHEN- | currently |
| | | TICATION | herewith |
| | | BASED ON | |
| | | USER/DEVICE | |
| | | INTERACTION | |
| 6017US1CIP2.014033.2561 | To be | DETERMINING | Con- |
| | assigned | USER AUTHEN- | currently |
| | | TICATION | herewith |
| | | BASED ON USER | |
| | | PATTERNS | |
| | | WITHIN | |
| | | APPLICATION | |
| 6929US1.014033.2562 | To be | PASSIVE BASED | Con- |
| | assigned | SECURITY | currently |
| | | ESCALATION TO | herewith |
| | | SHUT OFF OF | |
| | | APPLICATION | |
| | | BASED ON | |
| | | RULES EVENT | |
| | | TRIGGERING | |
| 6930US1.014033.2563 | To be | PERMANENTLY | Con- |
| | assigned | AFFIXED UN- | currently |
| | | DECRYPTABLE | herewith |
| | | IDENTIFIER | |
| | | ASSOCIATED | |
| | | WITH MOBILE | |
| | | DEVICE | |
| 6932US1.014033.2564 | To be | INTEGRATED | Con- |
| | assigned | FULL AND | currently |
| | | PARTIAL | herewith |
| | | SHUTDOWN | |
| | | APPLICATION | |
| | | PROGRAMMING | |
| | | INTERFACE | |
| 6933US1.014033.2565 | To be | TIERED | Con- |
| | assigned | IDENTIFI- | currently |
| | | CATION | herewith |
| | | FEDERATED | |
| | | AUTHEN- | |
| | | TICATION | |
| | | NETWORK | |
| | | SYSTEM | |

What is claimed is:

1. An apparatus for user authentication based on user/device interactions, the apparatus comprising:
a memory;
one or more processors; and
a security module stored in the memory, executable by the one or more processors, and configured to cause the one or more processors to:
communicate, to a computing device, code executable by the computing device that causes the computing device to monitor user patterns of a user based on the user physically interacting with one or more applications executed by the computing device;
receive, from the computing device, a baseline set of user patterns of the user for identifying the user;
identify, from the baseline set of user patterns, one or more routine actions performed by the user while operating the one or more applications executed by the computing device;
receive a request for the user to perform a transaction using the computing device, wherein the transaction is associated with a level of security that must be authenticated prior to completing the transaction;
receive, from the computing device, an identification set of user patterns of the user based on the user physically interacting with the one or more applications executed by the computing device;
determine a threshold score based on comparing the identification set of user patterns with the baseline set of user patterns; and
based on the threshold score, alter the level of security that must be authenticated prior to completing the transaction.

2. The apparatus of claim 1, wherein the level of security that must be authenticated prior to completing the transaction is one of a hard authentication and a soft authentication, wherein the hard authentication comprises two or more authentication credentials, and wherein the soft authentication comprises one authentication credential.

3. The apparatus of claim 2, wherein altering the level of security that must be authenticated prior to completing the transaction comprises changing the level of security, if the level of security is the hard authentication, from the hard authentication to the soft authentication, or changing the level of security, if the level of security is the soft authentication to no authentication.

4. The apparatus of claim 1, wherein the threshold score is associated with one of a fully authenticated tier, a partially authenticated tier, and no authenticated tier,
wherein altering the level of security when the threshold score is associated with the fully authenticated tier comprises requiring no authentication credentials prior to performing the transaction,
wherein altering the level of security when the threshold score is associated with the fully authenticated tier comprises requiring at least a partial number of the authentication credentials associated with the level of security prior to completing the transaction, and
wherein altering the level of security when the threshold score is associated with the fully authenticated tier comprises requiring all of the authentication credentials associated with the level of security and at least one other authentication credential not associated with the level of security.

5. The apparatus of claim 1, wherein the security module is further configured to cause the one or more processors to:
communicate a request for the user to submit a response to one or more credentials associated with the level of security;
receive the response to the one or more credentials associated with the level of security;
authenticate the user based on validating the response to the one or more credentials associated with the level of security; and
perform the transaction based on authenticating the user.

6. The apparatus of claim 1, wherein the user patterns of the user comprise at least one of a time of day when the user physically interacts with the one or more applications, specific pages within the one or more applications accessed by the user, software generated buttons or links selected by the user, user interface controls operated by the user, functions performed by the user, and the like.

7. The apparatus of claim 1, wherein the security module is further configured to cause the one or more processors to update the baseline set of user patterns using the identification set of user patterns based on receiving validating one or more authentication credentials associated with the level of security.

8. A method for user authentication based on user/device interactions, the method comprising:
receiving from a user, a request to execute a user action associated with an application, wherein execution of the user action requires validation of one or more authentication credentials;
communicating, to a computing device, code executable by the computing device that causes the computing device to monitor user patterns of a user based on the user physically interacting with one or more applications executed by the computing device;
receiving, from the computing device, a baseline set of user patterns of the user for identifying the user;
identifying, from the baseline set of user patterns, one or more routine actions performed by the user while operating one or more applications executed by the computing device;
receiving a request for the user to perform a transaction using the computing device, wherein the transaction is associated with a level of security that must be authenticated prior to completing the transaction;
receiving, from the computing device, an identification set of user patterns of the user based on the user physically interacting with the one or more applications executed by the computing device;
determining a threshold score based on comparing the identification set of user patterns with the baseline set of user patterns; and
based on the threshold score, altering the level of security that must be authenticated prior to completing the transaction.

9. The method of claim 8, wherein the level of security that must be authenticated prior to completing the transaction is one of a hard authentication and a soft authentication, wherein the hard authentication comprises two or more authentication credentials, and wherein the soft authentication comprises one authentication credential.

10. The method of claim 9, wherein altering the level of security that must be authenticated prior to completing the transaction comprises changing the level of security, if the level of security is the hard authentication, from the hard authentication to the soft authentication, or changing the level of security, if the level of security is the soft authentication to no authentication.

11. The method of claim 8, wherein the threshold score is associated with one of a fully authenticated tier, a partially authenticated tier, and no authenticated tier,
wherein altering the level of security when the threshold score is associated with the fully authenticated tier comprises requiring no authentication credentials prior to performing the transaction,
wherein altering the level of security when the threshold score is associated with the fully authenticated tier comprises requiring at least a partial number of the authentication credentials associated with the level of security prior to completing the transaction, and
wherein altering the level of security when the threshold score is associated with the fully authenticated tier comprises requiring all of the authentication credentials associated with the level of security and at least one other authentication credential not associated with the level of security.

12. The method of claim 8, further comprising:
communicating a request for the user to submit a response to one or more credentials associated with the level of security;
receiving the response to the one or more credentials associated with the level of security;
authenticating the user based on validating the response to the one or more credentials associated with the level of security; and
performing the transaction based on authenticating the user.

13. The method of claim 8, wherein the user patterns of the user comprise at least one of a time of day when the user physically interacts with the one or more applications, specific pages within the one or more applications accessed by the user, software generated buttons or links selected by the user, user interface controls operated by the user, functions performed by the user, and the like.

14. The method of claim 8, wherein the method further comprises updating the baseline set of user patterns using the identification set of user patterns based on receiving validating one or more authentication credentials associated with the level of security.

15. A computer program product for user authentication based on user/device interactions, the computer program product comprising a non-transitory computer-readable medium comprising code causing a first apparatus to:
communicate, to a computing device, code executable by the computing device that causes the computing device to monitor user patterns of a user based on the user physically interacting with one or more applications executed by the computing device;
receive, from the computing device, a baseline set of user patterns of the user for identifying the user;
identify, from the baseline set of user patterns, one or more routine actions performed by the user while operating one or more applications executed by the computing device;
receive a request for the user to perform a transaction using the computing device, wherein the transaction is associated with a level of security that must be authenticated prior to completing the transaction;
receive, from the computing device, an identification set of user patterns of the user based on the user physically interacting with the one or more applications executed by the computing device;
determine a threshold score based on comparing the identification set of user patterns with the baseline set of user patterns; and
based on the threshold score, alter the level of security that must be authenticated prior to completing the transaction.

16. The computer program product of claim 15, wherein the level of security that must be authenticated prior to completing the transaction is one of a hard authentication and a soft authentication, wherein the hard authentication comprises two or more authentication credentials, and wherein the soft authentication comprises one authentication credential.

17. The computer program product of claim 16, wherein altering the level of security that must be authenticated prior to completing the transaction comprises changing the level of security, if the level of security is the hard authentication, from the hard authentication to the soft authentication, or changing the level of security, if the level of security is the soft authentication to no authentication.

18. The computer program product of claim 15, wherein the threshold score is associated with one of a fully authenticated tier, a partially authenticated tier, and no authenticated tier,
wherein altering the level of security when the threshold score is associated with the fully authenticated tier comprises requiring no authentication credentials prior to performing the transaction,
wherein altering the level of security when the threshold score is associated with the fully authenticated tier comprises requiring at least a partial number of the authentication credentials associated with the level of security prior to completing the transaction, and
wherein altering the level of security when the threshold score is associated with the fully authenticated tier comprises requiring all of the authentication credentials associated with the level of security and at least one other authentication credential not associated with the level of security.

19. The computer program product of claim 15, wherein the non-transitory computer-readable medium comprising code causing the first apparatus to:
communicate a request for the user to submit a response to one or more credentials associated with the level of security;
receive the response to the one or more credentials associated with the level of security;
authenticate the user based on validating the response to the one or more credentials associated with the level of security; and
perform the transaction based on authenticating the user.

20. The computer program product of claim 15, wherein the user patterns of the user comprise at least one of a time of day when the user physically interacts with the one or more applications, specific pages within the one or more applications accessed by the user, software generated buttons or links selected by the user, user interface controls operated by the user, functions performed by the user, and the like.

21. An system for user authentication to perform at least one user action of a plurality of first user actions associated with an application running on an apparatus and based on user/device interactions patterns, the system comprising:
a memory;
a processor; and
computer-executable instructions stored in the memory, executable by the processor, and configured to cause the processor to:
receive from a user, a request to execute at least one user action from a plurality of user actions associated with an application, wherein execution of the at least one user action requires validation of one or more authentication credentials;
collect a set of data comprising information related to one or more physical user patterns based on the user initially interacting with the application;
determine a normal pattern of usage based on the collected set of data;
determine a present pattern of usage based on the user physically interacting with the application;
determine a user pattern score of the user, comprising:
comparing the present pattern of usage to the normal pattern of usage;
determining that the present pattern of usage is outside the normal pattern of usage;
setting the user pattern score by determining an extent to which the present pattern of usage is outside the normal pattern of usage;
determine a level of authentication associated with the determined user pattern score;
determine which one or more authentication types from a plurality of authentication types are associated with the level of authentication associated with the user pattern score;
request one or more authentication credentials corresponding to the determined one or more authentication types;
receive one or more authentication credentials from the user;
validate the one or more authentication credentials, thereby resulting in a successful validation of the one or more authentication credentials; and
in response to the successful validation of the one or more authentication credentials, execute the at least one user action.

22. The system of claim 21, wherein the application is executed by the system.
